(19) United States
(12) Patent Application Publication
(10) Pub. No.: US 2023/0405850 A1
(43) Pub. Date: Dec. 21, 2023

(54) DEVICE FOR ADJUSTING PARAMETER, ROBOT SYSTEM, METHOD, AND COMPUTER PROGRAM

(71) Applicant: FANUC CORPORATION, Yamanashi (JP)

(72) Inventor: Jun WADA, Yamanashi (JP)

(21) Appl. No.: 18/252,189

(22) PCT Filed: Nov. 11, 2021
(86) PCT No.: PCT/JP2021/041616

§ 371 Date: May 9, 2023

(30) Foreign Application Priority Data
Nov. 18, 2020 (JP) 2020-191918

(51) Int. Cl. B25J 19/04; G06T 7/73; G06T 17/00; B25J 9/16

(52) U.S. Cl. CPC B25J 19/04; G06T 7/75; G06T 17/00; B25J 9/1656; G06T 2200/24; G06T 2207/30164

(57) ABSTRACT

Conventionally, an operator with expertise was needed to adjust a parameter for collating a workpiece feature of a workpiece imaged by a visual sensor and a workpiece model of the workpiece. A device comprises: an image generation unit that generates image data displaying a workpiece feature of a workpiece imaged by a visual sensor; a position detection unit that uses a parameter for collating a workpiece model with a workpiece feature to obtain, as a detected position, a position of the workpiece in the image data; a matching position acquisition unit that acquires, as a matching position, a position of the workpiece model in the image data when the workpiece model is arranged so as to match the workpiece feature in the image data; and a parameter adjustment unit that adjusts the parameter on the basis of data indicating the difference between the detected position and the matching position.

### TECHNICAL FIELD

The present invention relates to a device that adjusts a parameter for collating a workpiece feature of a workpiece with a workpiece model in image data, a robot system, a method, and a computer program.

### BACKGROUND ART

A technique for acquiring a parameter for detecting a position of a workpiece shown in image data imaged by a vision sensor is known (e.g., Patent Document 1).

### CITATION LIST

### Patent Literature

Patent Document 1: JP 2-210584 A

### SUMMARY OF INVENTION

### Technical Problem

A workpiece feature of a workpiece shown in image data imaged by a vision sensor and a workpiece model obtained by modeling the workpiece may be collated with each other using a parameter, to obtain a position of the workpiece shown in the image data. In the related art, in order to adjust such a parameter for collation, an operator having expert knowledge has been required.

### Solution to Problem

In one aspect of the present disclosure, a device includes a position detecting section configured to obtain, as a detection position, a position of a workpiece in image data in which a workpiece feature of the workpiece imaged by a vision sensor is displayed, using a parameter for collating a workpiece model obtained by modeling the workpiece with the workpiece feature in the image data; a matching position acquiring section configured to acquire, as a matching position, a position of the workpiece model in the image data when the workpiece model is arranged so as to coincide with the workpiece feature in the image data; and a parameter adjustment section configured to adjust the parameter so as to enable the position detecting section to obtain the detection position as a position corresponding to the matching position, on the basis of data representing a difference between the detection position and the matching position.

In another aspect of the present disclosure, a method including, by a processor, obtaining, as a detection position, a position of a workpiece in image data in which a workpiece feature of the workpiece imaged by a vision sensor is displayed, using a parameter for collating a workpiece model obtained by modeling the workpiece with the workpiece feature in the image data; acquiring, as a matching position, a position of the workpiece model in the image data when the workpiece model is arranged so as to coincide with the workpiece feature in the image data; and adjusting the parameter so as to enable the position detecting section to obtain the detection position as a position corresponding to the matching position, on the basis of data representing a difference between the detection position and the matching position.

### Advantageous Effects of Invention

According to the present disclosure, the parameter is adjusted using the matching position acquired when the workpiece model is matched with the workpiece feature in the image data. Therefore, even an operator who does not have expert knowledge on the adjustment of the parameter can acquire the matching position and thus adjust the parameter.

### BRIEF DESCRIPTION OF DRAWINGS

FIG. 1 is a schematic view of a robot system according to one embodiment.

FIG. 2 is a block diagram of the robot system illustrated in FIG. 1.

FIG. 3 is a flowchart showing a parameter adjustment method according to one embodiment.

FIG. 4 illustrates an example of image data generated in step S3 in FIG. 3.

FIG. 5 illustrates an example of a flow of step S4 in FIG. 3.

FIG. 6 illustrates an example of image data generated in step S11 in FIG. 5.

FIG. 7 illustrates a state in which a workpiece model matches a workpiece feature in image data.

FIG. 8 illustrates an example of a flow of step S5 in FIG. 3.

FIG. 9 illustrates another example of the flow of step S4 in FIG. 3.

FIG. 10 illustrates an example of image data generated in step S11 in FIG. 9.

FIG. 11 illustrates another example of image data generated in step S11 in FIG. 9.

FIG. 12 illustrates an example of image data generated in step S32 in FIG. 9.

FIG. 13 illustrates a state in which workpiece models are randomly displayed in the image data generated in step S11 in FIG. 9.

FIG. 14 illustrates a state in which a workpiece model is displayed in accordance with a predetermined rule in the image data generated in step S11 in FIG. 9.

FIG. 15 illustrates still another example of the flow of step S4 in FIG. 3.

FIG. 16 illustrates an example of image data generated in step S42 in FIG. 15.

FIG. 17 illustrates an example of a flow of acquiring image data by a vision sensor.

FIG. 18 is a flowchart showing a parameter adjustment method according to another embodiment.

### DESCRIPTION OF EMBODIMENTS

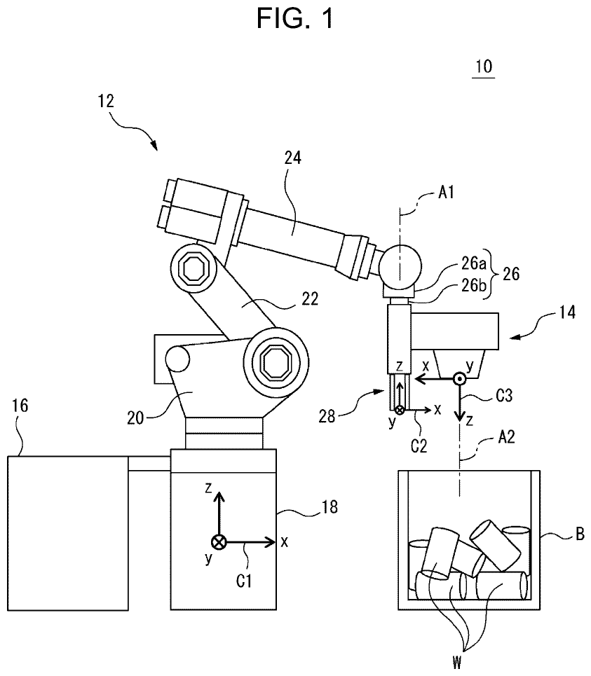

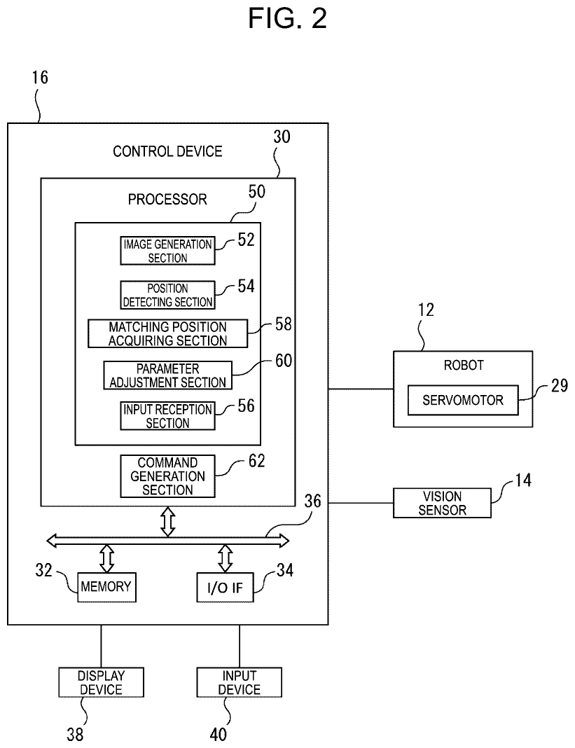

Hereinafter, embodiments of the present disclosure will be described in detail with reference to the drawings. In various embodiments described below, the same elements are designated by the same reference numerals and duplicate description will be omitted. First, a robot system 10 according to one embodiment will be described with reference to FIGS. 1 and 2. The robot system 10 includes a robot 12, a vision sensor 14, and a control device 16.

In the present embodiment, the robot 12 is a vertical articulated robot and includes a robot base 18, a rotary barrel 20, a lower arm 22, an upper arm 24, a wrist 26, and an end effector 28. The robot base 18 is fixed on the floor of a work cell. The rotary barrel 20 is provided on the robot base 18 so as to be able to rotate about a vertical axis.

The lower arm 22 is provided on the rotary barrel 20 so as to be pivotable about a horizontal axis, and the upper arm 24 is pivotally provided at a tip part of the lower arm 22. The wrist 26 includes a wrist base 26a pivotally provided at a tip part of the upper arm 24, and a wrist flange 26b provided at the wrist base 26a so as to be pivotable about a wrist axis A1.

The end effector 28 is detachably attached to the wrist flange 26b and performs a predetermined work on a workpiece W. In the present embodiment, the end effector 28 is a robot hand that can grip the workpiece W, and includes, for example, a plurality of openable and closable finger portions or a suction portion (a negative pressure generation device, a suction cup, an electromagnet, or the like).

A servomotor 29 (FIG. 2) is provided at each of the constituent elements (the robot base 18, the rotary barrel 20, the lower arm 22, the upper arm 24, and the wrist 26) of the robot 12. The servomotor 29 causes each of the movable elements (the rotary barrel 20, the lower arm 22, the upper arm 24, the wrist 26, and the wrist flange 26b) of the robot 12 to pivot about a drive shaft in response to a command from the control device 16. As a result, the robot 12 can move and arrange the end effector 28 at a given position and with a given orientation.

The vision sensor 14 is fixed to the end effector 28 (or the wrist flange 26b). For example, the vision sensor 14 is a three-dimensional vision sensor including an imaging sensor (CMOS, CCD, or the like) and an optical lens (a collimator lens, a focus lens, or the like) that guides a subject image to the imaging sensor, and is configured to image the subject image along an optical axis A2 and measure a distance d to the subject image.

As illustrated in FIG. 1, a robot coordinate system C1 and a tool coordinate system C2 are set in the robot 12. The robot coordinate system C1 is a control coordinate system for controlling the operation of each movable element of the robot 12. In the present embodiment, the robot coordinate system C1 is fixed to the robot base 18 such that the origin thereof is arranged at the center of the robot base 18 and the z axis thereof is parallel to the vertical direction.

The tool coordinate system C2 is a control coordinate system for controlling the position of the end effector 28 in the robot coordinate system C1. In the present embodiment, the tool coordinate system C2 is set with respect to the end effector 28 such that the origin (so-called TCP) thereof is arranged at the work position (workpiece gripping position) of the end effector 28 and the z axis thereof is parallel to (specifically, coincide with) the wrist axis A1.

When moving the end effector 28, the control device 16 sets the tool coordinate system C2 in the robot coordinate system C1, and generates a command to each servomotor 29 of the robot 12 so as to arrange the end effector 28 at a position represented by the set tool coordinate system C2. In this way, the control device 16 can position the end effector 28 at an arbitrary position in the robot coordinate system C1. Note that, in the present description, a “position” may refer to a position and an orientation.

A sensor coordinate system C3 is set in the vision sensor 14. The sensor coordinate system C3 defines the coordinates of each pixel of image data (or the imaging sensor) imaged by the vision sensor 14. In the present embodiment, the sensor coordinate system C3 is set with respect to the vision sensor 14 such that its origin is arranged at the center of the imaging sensor and its z axis is parallel to (specifically, coincides with) the optical axis A2.

The positional relationship between the sensor coordinate system C3 and the tool coordinate system C2 is known by calibration, and thus, the coordinates of the sensor coordinate system C3 and the coordinates of the tool coordinate system C2 can be mutually transformed through a known transformation matrix (e.g., a homogeneous transformation matrix). Furthermore, since the positional relationship between the tool coordinate system C2 and the robot coordinate system C1 is known, the coordinates of the sensor coordinate system C3 and the coordinates of the robot coordinate system C1 can be mutually transformed through the tool coordinate system C2.

The control device 16 controls the operation of the robot 12. Specifically, the control device 16 is a computer including a processor 30, a memory 32, and an I/O interface 34. The processor 30 is communicably connected to the memory 32 and the I/O interface 34 via a bus 36, and performs arithmetic processing for implementing various functions to be described later while communicating with these components.

The memory 32 includes a RAM, a ROM, or the like, and temporarily or permanently stores various types of data. The I/O interface 34 includes, for example, an Ethernet (registered trademark) port, a USB port, an optical fiber connector, or a HDMI (registered trademark) terminal and performs wired or wireless data communication with an external device in response to a command from the processor 30. Each servomotor 29 and the vision sensor 14 of the robot 12 are communicably connected to the I/O interface 34.

In addition, the control device 16 is provided with a display device 38 and an input device 40. The display device 38 and the input device 40 are communicably connected to the I/O interface 34. The display device 38 includes a liquid crystal display, an organic EL display, or the like, and displays various types of data in a visually recognizable manner in response to a command from the processor 30.

The input device 40 includes a keyboard, a mouse, a touch panel, or the like, and receives input data from an operator. Note that the display device 38 and the input device 40 may be integrally incorporated in the housing of the control device 16, or may be externally attached to the housing separately from the housing of the control device 16.

In the present embodiment, the processor 30 causes the robot 12 to operate to execute a workpiece handling work of gripping and picking up the workpieces W stacked in bulk in a container B with the end effector 28. In order to execute the workpiece handling work, the processor 30 first causes the vision sensor 14 to image the workpieces W in the container B.

Image data ID1 imaged by the vision sensor 14 at this time includes a workpiece feature WP that shows a visual feature point (an edge, a contour, a surface, a side, a corner, a hole, a protrusion, and the like) of each imaged workpiece W, and information on a distance d from the vision sensor 14 (specifically, the origin of the sensor coordinate system C3) to a point on the workpiece W represented by each pixel of the workpiece feature WP.

Next, the processor 30 acquires a parameter PM for collating a workpiece model WM obtained by modeling the workpiece W with the workpiece feature WP of the workpiece W imaged by the vision sensor 14. Then, the processor 30 applies the parameter PM to a predetermined algorithm AL (software), and collates the workpiece model WM with the workpiece feature WP in accordance with the algorithm AL, thereby acquiring data (specifically, the coordinates) of the position (specifically, the position and orientation) of the workpiece W shown in the image data ID1 in the sensor coordinate system C3. Then, the processor 30 transforms the acquired position in the sensor coordinate system C3 into the position in the robot coordinate system C1 to acquire position data of the imaged workpiece W in the robot coordinate system C1.

Here, in order to acquire the position of the workpiece W shown in the image data ID1 with high accuracy, the parameter PM needs to be optimized. In the present embodiment, the processor 30 adjusts the parameter PM such that the parameter PM is optimized, using the workpiece feature WP of the workpiece W imaged by the vision sensor 14.

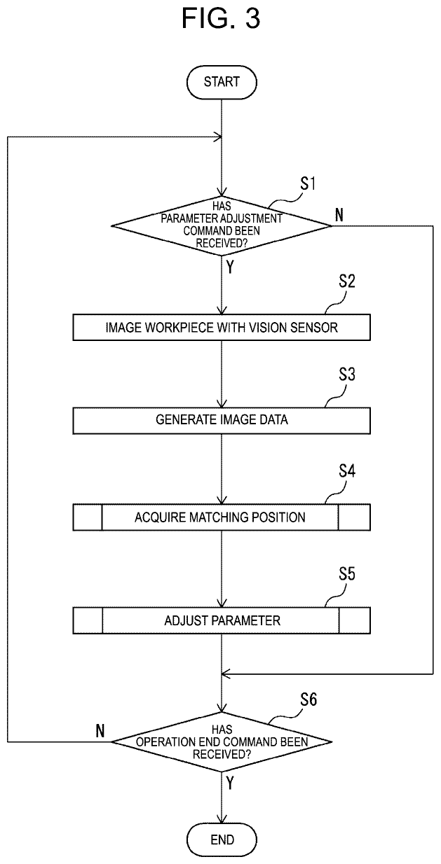

Hereinafter, a method of adjusting the parameter PM will be described with reference to FIG. 3. The flow shown in FIG. 3 is started, for example, when the control device 16 is activated. At the start of the flow of FIG. 3, the above-described algorithm AL and a parameter PM₁ prepared in advance are stored in the memory 32.

In step S1, the processor 30 determines whether or not a parameter adjustment command has been received. For example, the operator operates the input device 40 to manually input the parameter adjustment command. When receiving the parameter adjustment command from the input device 40 through the I/O interface 34, the processor 30 determines YES, and proceeds to step S2. On the other hand, when not receiving the parameter adjustment command, the processor 30 determines NO, and proceeds to step S6.

In step S2, the processor 30 causes the vision sensor 14 to image the workpieces W. Specifically, the processor 30 causes the robot 12 to operate to position the vision sensor 14 at an imaging position where at least one workpiece W fits in the field of view of the vision sensor 14, as illustrated in FIG. 1.

Next, the processor 30 sends an imaging command to the vision sensor 14, and in response to the imaging command, the vision sensor 14 images the workpieces W and acquires the image data ID1. As described above, the image data ID1 includes the workpiece feature WP of each imaged workpiece W and the information on the distance d described above. The processor 30 acquires the image data ID1 from the vision sensor 14. Each pixel of the image data ID1 is represented as coordinates in the sensor coordinate system C3.

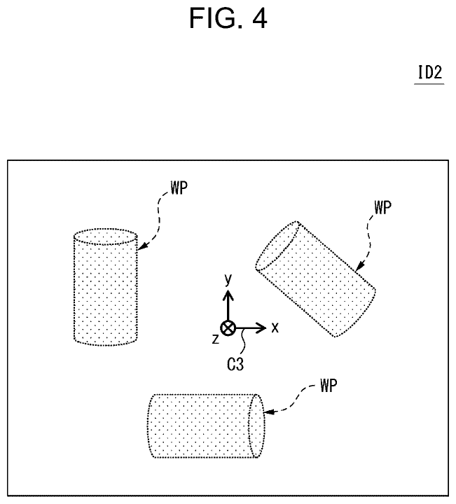

In step S3, the processor 30 generates image data ID2 in which the workpiece features WP are displayed. Specifically, the processor 30 generates the image data ID2 as a graphical user interface (GUI) through which the operator can visually recognize the workpiece features WP, on the basis of the image data ID1 acquired from the vision sensor 14. An example of the image data ID2 is illustrated in FIG. 4.

In the example illustrated in FIG. 4, the workpiece features WP are displayed as three-dimensional point groups in the image data ID2. Furthermore, the sensor coordinate system C3 is set in the image data ID2, and each pixel of the image data ID2 is represented as coordinates in the sensor coordinate system C3, as in the case of the image data ID1 imaged by the vision sensor 14.

Each of the plurality of points constituting the workpiece feature WP has the information on the distance d described above, and thus can be expressed as three-dimensional coordinates (x, y, z) in the sensor coordinate system C3. That is, in the present embodiment, the image data ID2 is three-dimensional image data. Although FIG. 4 illustrates an example in which a total of three workpiece features WP are displayed in the image data ID2 for the sake of easy understanding, it should be understood that more workpiece features WP (i.e., the workpieces W) can be practically displayed.

The processor 30 may generate the image data ID2 as image data different from the image data ID1 as a GUI excelling in visibility compared with the image data ID1. For example, the processor 30 may generate the image data ID2 such that the operator can easily identify the workpiece features WP by coloring (black, blue, red, or the like) the workpiece features WP while making the region other than the workpiece features WP shown in the image data ID1 colorless.

The processor 30 causes the display device 38 to display the generated image data ID2. Thus, the operator can visually recognize the image data ID2 as illustrated in FIG. 4. As described above, in the present embodiment, the processor 30 functions as an image generation section 52 (FIG. 2) that generates the image data ID2 in which the workpiece features WP are displayed.

Note that the processor 30 may update the image data ID2 displayed on the display device 38 so as to change the viewing direction of the workpieces W shown in the image data ID2 according to the operation of the input device 40 by the operator (e.g., as in 3D CAD data). In this case, the operator can visually recognize the workpieces W shown in the image data ID2 from a desired direction, by operating the input device 40.

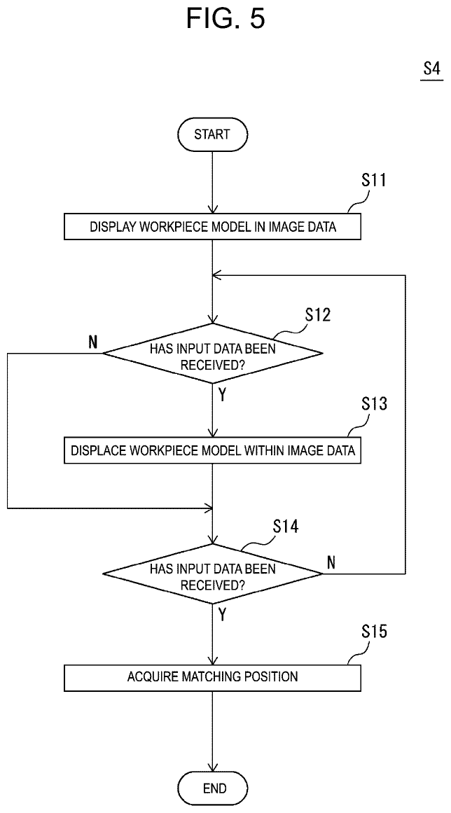

FIG. 3 is referred to again. In step S4, the processor 30 performs a process of acquiring a matching position. Step S4 will be described with reference to FIG. 5. In step S11, the processor further displays the workpiece models WM in the image data ID2 generated in step S3 described above. In the present embodiment, the workpiece model WM is 3D CAD data.

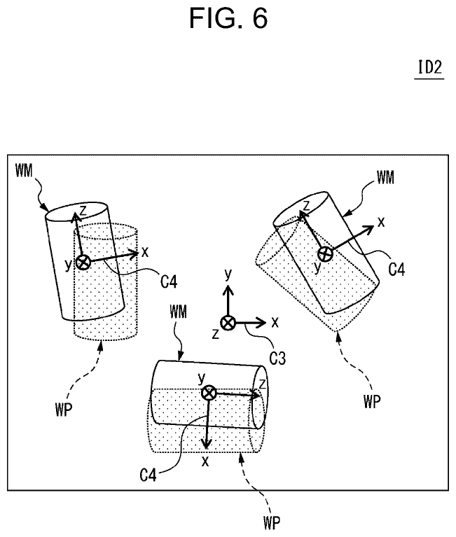

FIG. 6 illustrates an example of the image data ID2 generated in step S11. In step S11, the processor 30 arranges the workpiece models WM in a virtual space defined by the sensor coordinate system C3, and generates the image data ID2 of the virtual space in which the workpiece models WM are arranged together with the workpiece features WP of the workpieces W. The processor 30 sets the workpiece coordinate system C4 together with the workpiece models WM in the sensor coordinate system C3. The workpiece coordinate system C4 is a coordinate system that defines the position (specifically, the position and orientation) of the workpiece model WM.

In the present embodiment, in step S11, the processor 30 uses the parameter PM₁ stored in the memory 32 at the start of step S11 to obtain the position of the workpiece W in the image data ID2 as a detection position DP₁. When obtaining the detection position DP₁, the processor applies the parameter PM₁ to the algorithm AL, and collates the workpiece model WM with the workpiece feature WP shown in the image data ID2, in accordance with the algorithm AL.

More specifically, the processor 30 gradually changes, by a predetermined displacement amount E, the position of the workpiece model WM in the virtual space defined by the sensor coordinate system C3, in accordance with the algorithm AL to which the parameter PM₁ is applied, and searches for the position of the workpiece model WM where a feature point (an edge, a contour, a surface, side, a corner, a hole, a protrusion, or the like) of the workpiece model WM and the feature point of the workpiece feature WP corresponding to the feature point coincide with each other.

When the feature point of the workpiece model WM coincides with the feature point of the corresponding workpiece feature WP, the processor 30 detects, as the detection position DP₁, coordinates (x, y, z, W, P, R) in the sensor coordinate system C3 of the workpiece coordinate system C4 set in the workpiece model WM. Here, the coordinates (x, y, z) indicate the origin position of the workpiece coordinate system C4 in the sensor coordinate system C3, and coordinates (W, P, R) indicate the orientation (so-called yaw, pitch, roll) of the workpiece coordinate system C4 with respect to the sensor coordinate system C3.

The above-described parameter PM₁ is for collating the workpiece model WM with the workpiece feature WP, and includes, for example, the above-described displacement amount E, a size SZ of a window that defines a range where feature points to be collated with each other in the image data ID2 are searched for, image roughness (or resolution) σ at the time of collation, and data that identifies which feature point of the workpiece model WM and which feature point of the workpiece feature WP are to be collated with each other (e.g., data identifying the “contours” of the workpiece model WM and the workpiece feature WP to be collated with each other).

In this manner, the processor 30 acquires the detection position DP₁ (x, y, z, W, P, R) by collating the workpiece model WM and the workpiece feature WP with each other using the parameter PM₁. Therefore, in the present embodiment, the processor 30 functions as a position detecting section 54 (FIG. 2) that obtains the detection position DP₁ using the parameter PM₁.

Next, the processor 30 functions as an image generation section 52 and displays the workpiece model WM at the acquired detection position DP₁ in the image data ID2. Specifically, the processor 30 displays the workpiece WM at the position represented by the workpiece coordinate system C4 arranged at the coordinates (x, y, z, W, P, R) in the sensor coordinate system C3 detected as the detection position DP₁.

In this way, as illustrated in FIG. 6, three workpiece models WM are displayed at respective positions corresponding to the three workpiece features WP in the image data ID2. Here, in a case where the parameter PM₁ is not optimized, as illustrated in FIG. 6, the acquired detection position DP₁ (i.e., the position of the workpiece model WM displayed in FIG. 6) may deviate from the workpiece feature WP.

FIG. 5 is referred to again. In step S12, the processor 30 determines whether or not input data IP1 (first input data) for displacing the position of the workpiece model WM in the image data ID2 has been received. Specifically, while visually recognizing the image data ID2 illustrated in FIG. 6 displayed on the display device 38, the operator inputs the input data IP1 by operating the input device 40 to move the workpiece model WM displayed in the image data ID2 to a position coinciding with the corresponding workpiece feature WP, on the image.

When receiving the input data IP1 from the input device 40 through the I/O interface 34, the processor 30 determines YES, and proceeds to step S13. On the other hand, when the input data IP1 is not received from the input device 40, NO is determined, and the process proceeds to step S14. As described above, in the present embodiment, the processor 30 functions as an input reception section 56 (FIG. 2) that receives the input data IP1 for displacing the position of the workpiece model WM in the image data ID2.

In step S13, the processor 30 displaces the position of the workpiece model WM displayed in the image data ID2, in response to the input data IP1. Specifically, the processor 30 functions as the image generation section 52 and updates the image data ID2 so as to displace, in response to the input data IP1, the position of the workpiece model WM in the virtual space defined by the sensor coordinate system C3. In this way, the operator operates the input device 40 while visually recognizing the image data ID2 displayed on the display device 38, so that the workpiece model WM can be displaced so as to approach the corresponding workpiece feature WP in the image data ID2.

In step S14, the processor 30 determines whether or not the input data IP2 for acquiring the matching position MP has been received. Specifically, when the position of the workpiece model WM coincides with the position of the workpiece feature WP in the image data ID2 as a result of the displacement of the workpiece model WM in step S13, the operator operates the input device 40 to input the input data IP2 for acquiring the matching position MP.

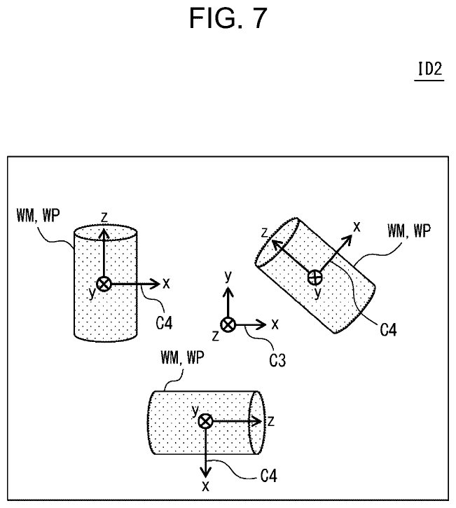

FIG. 7 illustrates a state in which the position of the workpiece model WM coincides with the workpiece feature WP in the image data ID2. When receiving the input data IP2 from the input device 40 through the I/O interface 34, the processor 30 determines YES and proceeds to step S15, and when not receiving the input data IP2 from the input device 40, the processor 30 determines NO and returns to step S12. In this way, the processor 30 repeats steps S12 to S14 until determining YES in step S14.

In step S15, the processor 30 acquires, as the matching position MP, the position of the workpiece model WM in the image data ID2 when the input data IP2 is received. As described above, when the processor 30 receives the input data IP2, the workpiece model WM coincides with the corresponding workpiece feature WP in the image data ID2, as illustrated in FIG. 7.

The processor 30 acquires, as the matching position MP, the coordinates (x, y, z, W, P, R) in the sensor coordinate system C3 of the workpiece coordinate system C4 set in each of the workpiece models WM illustrated in FIG. 7, and stores the coordinates in the memory 32. In this manner, in the present embodiment, the processor 30 functions as a matching position acquiring section 58 (FIG. 2) that acquires the matching position MP.

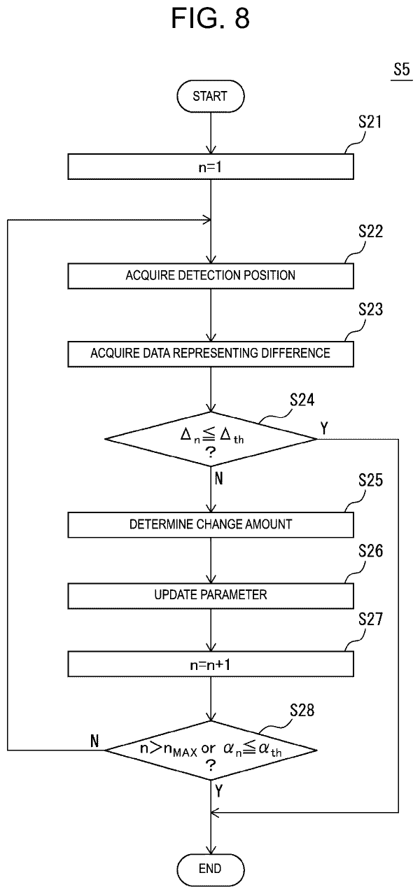

FIG. 3 is referred to again. In step S5, the processor 30 executes a process of adjusting the parameter PM. This step S5 will be described with reference to FIG. 8. In step S21, the processor sets the number “n” determining the number of times of updates of a parameter PMₙ to “1”.

In step S22, the processor 30 functions as the position detecting section 54 and acquires a detection position DPₙ. Specifically, the processor 30 obtains the detection position DPₙ using the parameter PMₙ stored in the memory 32 at the start of step S22. If n=1 is set at the start of step S22 (i.e., when the first step S22 is executed), the processor 30 obtains the detection position DP₁ illustrated in FIG. 6, using the parameter PM₁ as in step S11 described above.

In step S23, the processor 30 obtains data Δₙ representing a difference between the detection position DPₙ obtained in the latest step S22 and the matching position MP obtained in step S4 described above. The data Δₙ is, for example, a value of an objective function representing a difference between the detection position DPₙ and the matching position MP in the sensor coordinate system C3. The objective function may be, for example, a function representing a sum, a square sum, an average value, or a square average value of the difference between the detection position DPₙ and the matching position MP, which are a pair, corresponding to each other. The processor 30 stores the acquired data Δₙ in the memory 32.

If n=1 is set at the start of step S23 (i.e., if the first step S23 is executed), the processor 30 obtains data Δ₁ representing the difference between the detection position DP₁ and the matching position MP. The data Δ₁ represents a difference between the position in the sensor coordinate system C3 of the workpiece model WM illustrated in FIG. 6 (i.e., the detection position DP₁) and the position in the sensor coordinate system C3 of the workpiece model WM illustrated in FIG. 7 (i.e., the matching position MP).

In step S24, the processor 30 determines whether or not the value of the data Δₙ acquired in the latest step S23 is less than or equal to a predetermined threshold value Δₜₕ(Δₙ≤Δₜₕ). The threshold value Δₜₕ is determined by the operator and stored in the memory 32 in advance. When Δₙ≤Δₜₕ, the processor 30 determines YES, ends step S5, and proceeds to step S6 in FIG. 3.

When YES is determined in step S24, the detection position DPₙ obtained in the latest step S22 substantially coincides with the matching position MP, and therefore, the parameter PMₙ can be regarded as being optimized. When Δₙ>Δₜₕ, the processor 30 determines NO, and proceeds to step S25.

In step S25, the processor 30 determines, on the basis of the data Δₙ acquired in the latest step S23, the change amount αₙ of the parameter PMₙ with which the difference between the detection position DPₙ and the matching position MP can be reduced in the image data ID2. Specifically, the processor 30 determines, on the basis of the data Δₙ acquired in the latest step S23, the change amount αₙ of the parameter PMₙ (e.g., the displacement amount E, the size SZ, or the image roughness σ) with which the value of the data Δₙ acquired in step S23 can be converged toward zero in the loop of steps S22 to S28 in FIG. 8 repeatedly executed. The processor 30 can obtain the change amount αₙ using the data Δₙ and a predetermined algorithm.

In step S26, the processor 30 updates the parameter PMₙ. Specifically, the processor 30 changes the parameter PMₙ (e.g., the displacement amount E, the size SZ, or the image roughness σ) by the change amount αₙ determined in the latest step S25, thereby updating the parameter PMₙ to obtain a new parameter PMₙ₊₁. The processor 30 stores the updated parameter PMₙ₊₁ in the memory 32. If n=1 is set at the start of step S26, the processor 30 changes the parameter PM₁ prepared in advance by a change amount α₁ to update the parameter PM₁ to a parameter PM₂.

In step S27, the processor 30 increments the number “n” that determines the number of times of updates of the parameter PMₙ by “1” (n=n+1). In step S28, the processor 30 determines whether or not the number “n” determining the number of times of updates of the parameter PMₙ exceeds a maximum value n_{MAX} (n>n_{MAX}) or whether or not the change amount an determined in the latest step S25 is less than or equal to the predetermined threshold value αₜₕ (αₙ≤αₜₕ). The maximum value n_{MAX} and the threshold value αₜₕ are determined in advance by the operator and stored in the memory 32.

Here, as illustrated in FIG. 8, the processor 30 repeatedly executes the loop of steps S22 to S28 until YES is determined in step S24 or S28. Since the processor 30 determines, in the above-described step S25, the change amount αₙ such that the difference between the detection position DPₙ and the matching position MP (i.e., the value of the data Δₙ) is reduced, the value of the data Δₙ acquired in step S23 and the change amount an determined in step S25 decrease every time the loop of steps S22 to S28 is repeated.

Therefore, when the change amount αₙ becomes less than or equal to the threshold value αₜₕ, the parameter PMₙ can be regarded as being optimized. Even if the loop of steps S22 to S28 is repeatedly executed many times, the change amount αₙ converges to a certain value (>αₜₕ) and becomes less than or equal to the threshold value αₜₕ, in some cases. Even in such a case, the parameter PMₙ can be regarded as being sufficiently optimized.

Therefore, in step S28, the processor 30 determines whether or not n>n_{MAX} or αₙ≤αₜₕ is satisfied, where when n>n_{MAX} or αₙ≤αₜₕ is satisfied, the processor 30 determines YES and ends step S5. When n≤n_{MAX} and αₙ≥αₜₕ are satisfied, the processor 30 determines NO, returns to step S22, and executes the loop of steps S22 to S28 using the updated parameter PMₙ₊₁.

In this way, the processor 30 updates and adjusts the parameter PMₙ on the basis of the data Δₙ by repeatedly executing the series of operations in steps S22 to S28 until the processor 30 determines YES in step S24 or S28. Therefore, in the present embodiment, the processor 30 functions as a parameter adjustment section 60 (FIG. 2) that adjusts the parameter PMₙ on the basis of the data Δₙ.

When functioning as the position detecting section 54 and obtaining the detection position DPₙ on the basis of the image data ID2, the processor 30 uses the parameter PMₙ optimized as described above. Thus, the processor 30 can obtain the detection position DPₙ in the image data ID2 as a position corresponding to (e.g., substantially coinciding with) the matching position MP.

FIG. 3 is referred to again. In step S6, the processor 30 determines whether or not an operation end command has been received. For example, the operator operates the input device 40 to manually input the operation end command. When receiving the operation end command from the input device 40 through the I/O interface 34, the processor 30 determines YES, and ends the operation of the control device 16. On the other hand, when receiving no operation end command, the processor 30 determines NO and returns to step S1.

For example, after the end of step S5, the operator changes the arrangement of the workpieces W in the container B illustrated in FIG. 1 without inputting the operation end command Next, the operator operates the input device 40 to input the parameter adjustment command described above. Then, the processor 30 determines YES in step S1, executes steps S2 to S5 on the workpieces W whose arrangement in the container B have been changed, to adjust the parameter PMₙ. In this way, the parameter PMₙ can be optimized for the workpieces W arranged at various positions by executing steps S2 to S5 every time the arrangement of the workpieces W in the container B is changed.

As described above, in the present embodiment, the processor 30 functions as the image generation section 52, the position detecting section 54, the input reception section 56, the matching position acquiring section 58, and the parameter adjustment section 60 to adjust the parameter PM. Therefore, the image generation section 52, the position detecting section 54, the input reception section 56, the matching position acquiring section 58, and the parameter adjustment section 60 constitute the device 50 for adjusting the parameter PM (FIG. 2).

In the device 50, the parameter PM is adjusted using the matching position MP acquired when the workpiece model WM is matched with the workpiece feature WP in the image data ID2. Therefore, even an operator who does not have expert knowledge on the adjustment of the parameter PM can acquire the matching position MP and thereby adjust the parameter PM.

Furthermore, in the present embodiment, the processor 30 adjusts the parameter PMₙ by repeatedly executing the series of operations of steps S22 to S28 in FIG. 8. With this configuration, the parameter PMₙ can be automatically adjusted, and the parameter PMₙ can be quickly optimized.

In the present embodiment, the processor 30 functions as the image generation section 52, further displays the workpiece model WM in the image data ID2 (step S11), and displaces the position of the workpiece model WM displayed in the image data ID2 in response to the input data IP1 (step S13). Then, when the workpiece model WM is arranged so as to coincide with the workpiece feature WP in the image data ID2, the processor 30 functions as the matching position acquiring section 58 and acquires the matching position MP (step S15).

With this configuration, the operator can easily cause the workpiece model WM to coincide with the workpiece feature WP in the image data ID2 by operating the input device 40 while visually recognizing the image data ID2 displayed on the display device 38, and thus the matching position MP can be acquired. Therefore, even an operator who does not have expert knowledge on adjustment of the parameter PM can easily acquire the matching position MP by merely aligning the workpiece model WM with the workpiece feature WP on the image.

After adjusting the parameter PMₙ as described above, the processor 30 causes the robot 12 to execute a work (specifically, a workpiece handling work) on the workpiece W, using the adjusted parameter PMₙ. Hereinafter, the work on the workpiece W executed by the robot 12 will be described. When receiving a work start command from an operator, a host controller, or a computer program, the processor 30 causes the robot 12 to operate so that the vision sensor 14 is positioned at an imaging position where the workpieces W in the container B can be imaged, and causes the vision sensor 14 to operate so that the workpieces W are imaged.

Image data ID3 imaged by the vision sensor 14 at this time shows the workpiece feature WP of at least one workpiece W. The processor 30 acquires the image data ID3 from the vision sensor 14 through the I/O interface 34, and generates an operation command CM for operating the robot 12 on the basis of the image data ID3.

More specifically, the processor 30 functions as the position detecting section 54, applies the adjusted parameter PMₙ to the algorithm AL, and collates the workpiece model WM with the workpiece feature WP shown in the image data ID3, in accordance with the algorithm AL. As a result, the processor 30 acquires a detection position DP ID3 in the image data ID3 as the coordinates in the sensor coordinate system C3.

Next, the processor 30 converts the acquired detection position DP_{ID3} into the position in the robot coordinate system C1 (or the tool coordinate system C2) to acquire the position data PD in the robot coordinate system C1 (or the tool coordinate system C2) of the imaged workpiece W. Next, the processor 30 generates the operation command CM for controlling the robot 12 on the basis of the acquired position data PD, and controls each servomotor 29 in accordance with the operation command CM, thereby causing the robot 12 to execute a workpiece handling work of gripping and picking up the workpiece W whose position data PD has been acquired with the end effector 28.

As described above, in the present embodiment, the processor 30 functions as a command generation section 62 that generates the operation command CM. Since the accurate detection position DP_{ID3} (i.e., position data PD) can be detected using the adjusted parameter PMₙ, the processor 30 can cause the robot 12 to execute the workpiece handling work with high accuracy.

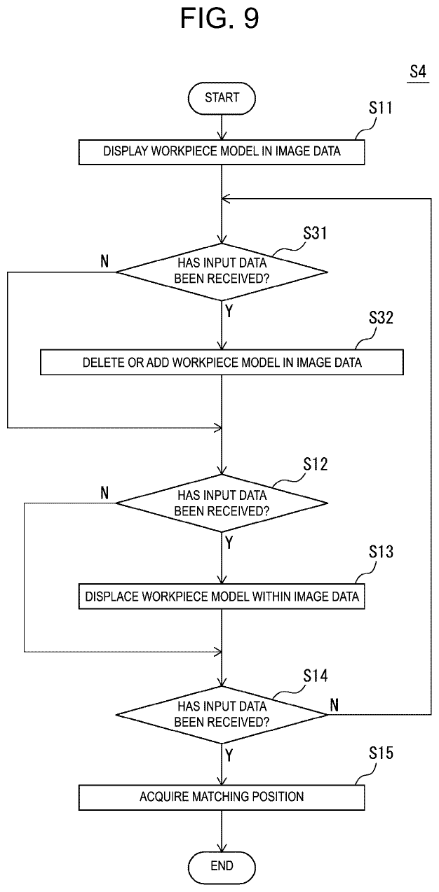

Next, another example of the above-described step S4 (i.e., the process of acquiring the matching position) will be described with reference to FIG. 9. In the flow shown in FIG. 9, the same process as that in the flow shown in FIG. 5 is denoted by the same step number and redundant description thereof will be omitted. In step S4 shown in FIG. 9, the processor 30 executes steps S31 and S32 after step S11.

Specifically, in step S31, the processor 30 determines whether or not input data IP3 (second input data) for deleting the workpiece model WM from the image data ID2 or input data IP4 (second input data) for adding another workpiece model WM to the image data ID2 has been received.

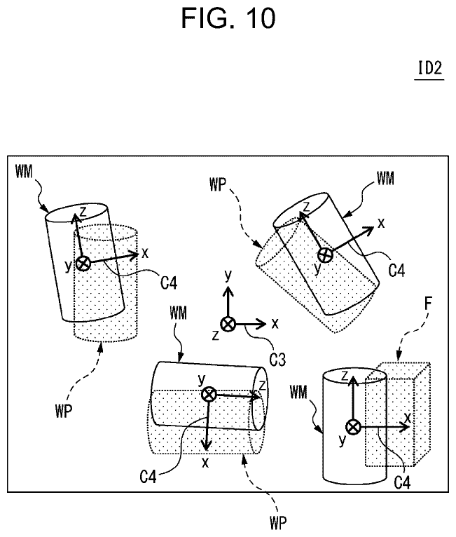

Here, in step S11 described above, the processor 30 may erroneously display the workpiece model WM at an inappropriate position. FIG. 10 illustrates an example of the image data ID2 in which the workpiece models WM are displayed at inappropriate positions. In the image data ID2 illustrated in FIG. 10, a feature F of a member different from the workpiece W is included.

When obtaining the detection position DP₁ using the parameter PM₁, the processor 30 may erroneously recognize the feature F as the workpiece feature WP of the workpiece W and obtain the detection position DP₁ corresponding to the feature F. In such a case, the operator needs to delete the workpiece model WM displayed at the position corresponding to the feature F from the image data ID2.

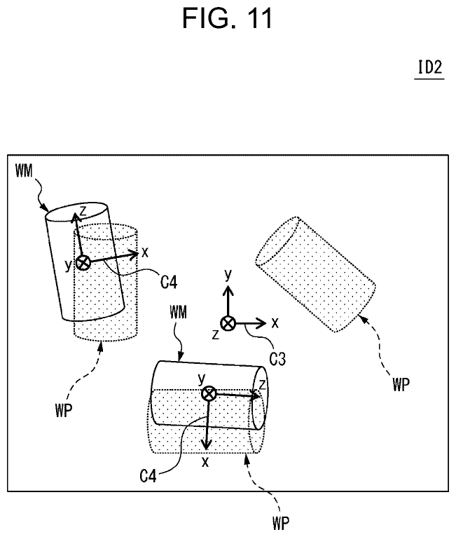

In step S11 described above, in some cases, the processor 30 cannot recognize the workpiece feature WP shown in the image data ID2 and fails to display the workpiece model WM. Such an example is illustrated in FIG. 11. In the image data ID2 illustrated in FIG. 11, the workpiece model WM corresponding to the upper right workpiece feature WP among the total of three workpiece features WP is not displayed. In such a case, the operator needs to add the workpiece model WM to the image data ID2.

Therefore, in the present embodiment, the processor 30 is configured to receive the input data IP3 for deleting the workpiece model WM from the image data ID2 and the input data IP4 for adding another workpiece model WM to the image data ID2. Specifically, when the image data ID2 illustrated in FIG. 10 is displayed in step S11, the operator operates the input device 40 while visually recognizing the image data ID2, to input the input data IP3 specifying the workpiece model WM to be deleted.

When the image data ID2 illustrated in FIG. 11 is displayed in step S11, the operator operates the input device 40 while visually recognizing the image data ID2, to input the input data IP4 specifying the position (e.g., coordinates) of the workpiece model WM to be added in the image data ID2 (the sensor coordinate system C3).

In step S31, the processor 30 determines YES when receiving the input data IP3 or IP4 from the input device 40 through the I/O interface 34, and proceeds to step S32. When receiving no input data IP3 or IP4 from the input device 40, NO is determined, and the process proceeds to step S12.

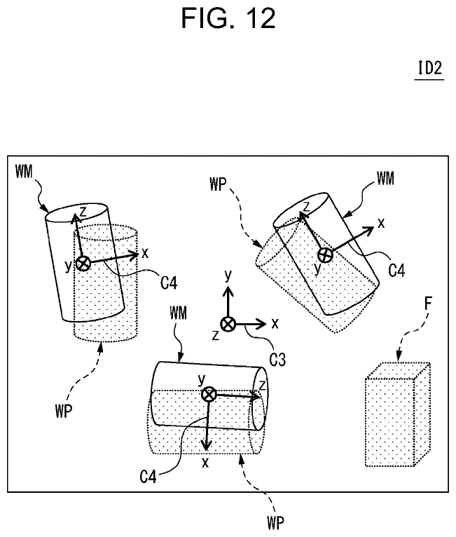

In step S32, the processor 30 functions as the image generation section 52, and deletes the displayed workpiece model WM from the image data ID2 or additionally displays another workpiece model WM in the image data ID2, in accordance with the received input data IP3 or IP4. For example, when receiving the input data IP3, the processor 30 deletes the workpiece model WM displayed at the position corresponding to the feature F from the image data ID2 illustrated in FIG. 10. As a result, the image data ID2 is updated as illustrated in FIG. 12.

When receiving the input data IP4, the processor 30 additionally displays the workpiece model WM at the position specified by the input data IP4 in the image data ID2 illustrated in FIG. 11. As a result, as illustrated in FIG. 6, all the total of three workpiece models WM are displayed in the image data ID2 so as to correspond to the respective workpiece features WP.

After step S32, the processor 30 executes steps S12 to S15 as in the flow of FIG. 5. Note that, in the flow shown in FIG. 9, when determining NO in step S14, the processor 30 returns to step S31. As described above, according to the present embodiment, the operator can delete or add the workpiece model WM as necessary in the image data ID2 displayed in step S11.

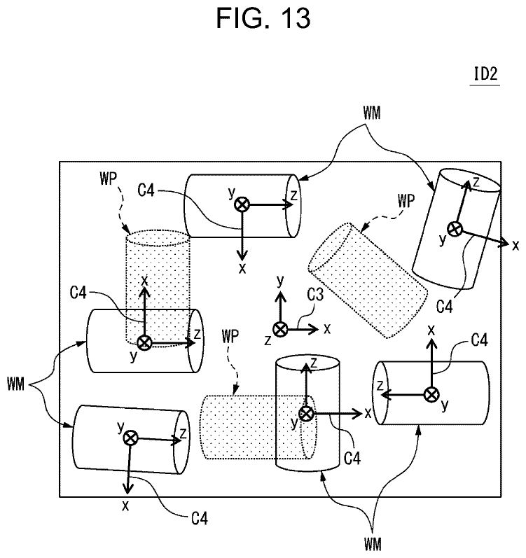

In step S11 in FIG. 9, the processor 30 may display the workpiece models WM at positions randomly determined in the image data ID2. FIG. 13 illustrates an example in which the processor 30 randomly displays the workpiece models WM in the image data ID2. In this case, the processor 30 may randomly determine the number of workpiece models WM to be arranged in the image data ID2, or the operator may determine the number thereof in advance.

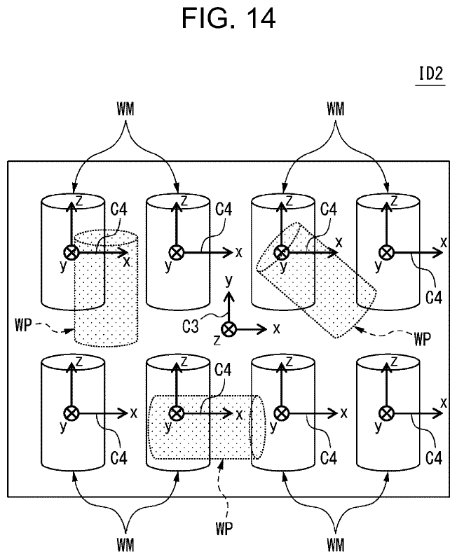

Alternatively, in step S11 in FIG. 9, the processor 30 may display, in the image data ID2, the workpiece models WM at positions determined in accordance with a predetermined rule. For example, this rule can be defined as a rule for arranging the workpiece models WM in a lattice form at equal intervals in the image data ID2. FIG. 14 illustrates an example in which the processor 30 displays the workpiece models WM in the image data ID2 in accordance with a rule for arranging the workpiece models WM in a lattice form at equal intervals.

After the processor 30 arranges the workpiece models WM randomly or in accordance with a predetermined rule in step S11, the operator can delete or add the workpiece model WM displayed in the image data ID2 as necessary by inputting the input data IP3 or IP4 to the input device 40 in step S31.

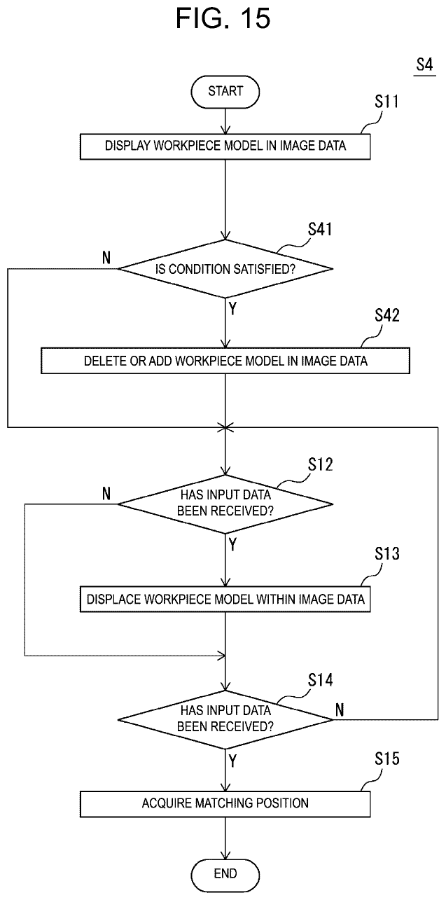

Next, still another example of step S4 (a process of acquiring the matching position) described above will be described with reference to FIG. 15. In step S4 shown in FIG. 15, the processor 30 executes steps S41 and S42 after step S11. In step S41, the processor 30 determines whether or not there is the workpiece model WM satisfying the condition G1 to be a deletion target in the image data ID2.

Specifically, for each of the workpiece models WM shown in the image data ID2, the processor 30 calculates the number N of points (or pixels showing the workpiece feature WP) of the three-dimensional point group constituting the workpiece feature WP existing in the occupying region of the workpiece model WM. Then, in step S41, the processor 30 determines whether or not the calculated number N is smaller than or equal to a predetermined threshold value Nₜₕ(N≤Nₜₕ) for each of the workpiece models WM, and when there is the workpiece model WM determined to have N≤Nₜₕ, the processor 30 identifies the workpiece model WM as a deletion target and determines YES. That is, in the present embodiment, the condition G1 is defined as the number N being smaller than or equal to the threshold value Nₜₕ.

For example, assume that the processor 30 generates the image data ID2 illustrated in FIG. 14 in step S11. In this case, for the second and fourth workpiece models WM from the left side of the upper column and the first, third, and fourth work models WM from the left side of the lower column among the workpiece models WM shown in the image data ID2, the number of points (pixels) of the workpiece features WP existing in the occupying regions of the workpiece models WM is small Therefore, in this case, the processor 30 identifies a total of five workpiece models WM as deletion targets and determines YES in step S11.

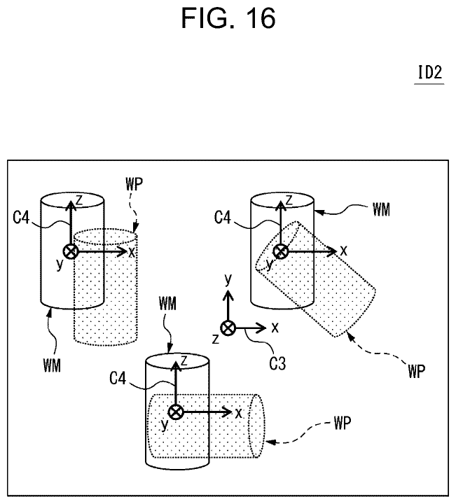

In step S42, the processor 30 functions as the image generation section 52, and automatically deletes the workpiece models WM identified as deletion targets in step S41 from the image data ID2. In the case of the example illustrated in FIG. 14, the processor 30 automatically deletes the above-described total of five workpiece models WM identified as deletion targets from the image data ID2. FIG. 16 illustrates an example of the image data ID2 from which the five workpiece models WM have been deleted. Thus, in the present embodiment, the processor 30 automatically deletes the displayed workpiece models WM from the image data ID2 in accordance with the predetermined condition G1.

Alternatively, in step S41, the processor 30 may determine whether or not a condition G2 for adding the workpiece model WM in the image data ID2 is satisfied. For example, assume that the processor 30 generates the image data ID2 illustrated in FIG. 11 in step S11. The processor determines whether or not each workpiece feature WP has a point (or a pixel) included in the occupying region of the workpiece model WM.

When there is the workpiece feature WP that does not have a point (pixel) included in the occupying region of the workpiece model WM, the processor 30 identifies the workpiece feature WP as a model addition target and determines YES. That is, in the present embodiment, the condition G2 is defined as the presence of the workpiece feature WP not having a point (pixel) included in the occupying region of the workpiece model WM. For example, in the case of the example illustrated in FIG. 11, in step S41, the processor 30 identifies the workpiece feature WP shown at the upper right of the image data ID2 as a model addition target, and determines YES.

Then, in step S42, the processor 30 functions as the image generation section 52, and automatically adds the workpiece model WM to the image data ID2 at the position corresponding to the workpiece feature WP identified as the model addition target in step S41. As a result, the workpiece model WM is added as illustrated in FIG. 6, for example.

In this manner, in the present embodiment, the processor 30 additionally displays the workpiece model WM in the image data ID2 in accordance with the predetermined condition G2. According to the flow shown in FIG. 15, since the processor 30 can automatically delete or add the workpiece model WM in accordance with the condition G1 or G2, the work of the operator can be reduced.

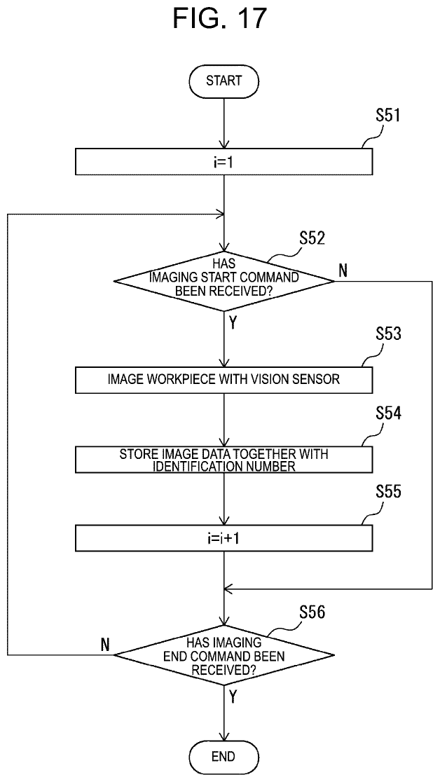

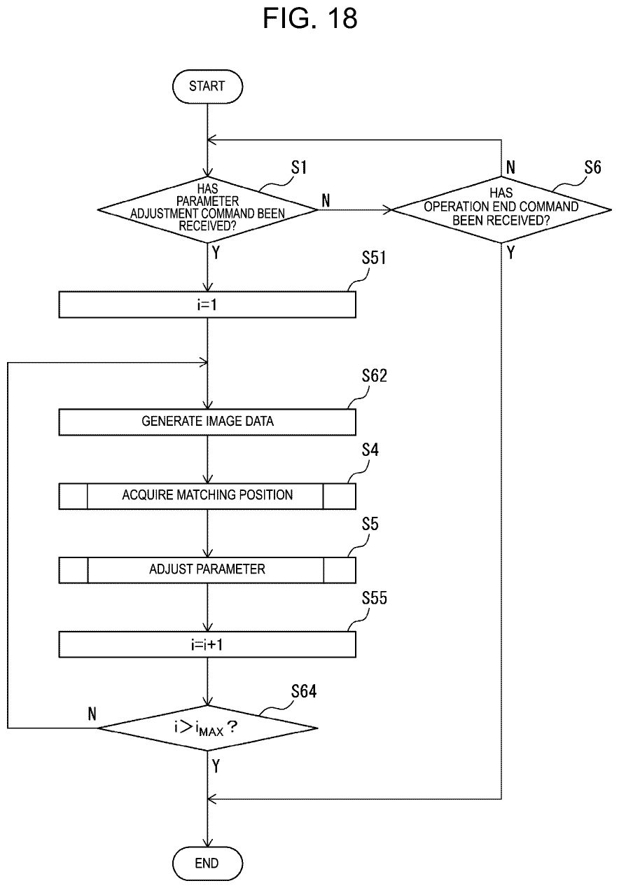

Next, other functions of the robot system 10 will be described with reference to FIGS. 17 and 18. In the present embodiment, the processor 30 first executes the image acquisition process shown in FIG. 17. In step S51, the processor 30 sets the number “i” for identifying the image data ID1_ᵢ imaged by the vision sensor 14 to “1”.

In step S52, the processor 30 determines whether or not an imaging start command has been received. For example, the operator operates the input device 40 to input the imaging start command. When receiving the imaging start command from the input device 40 through the I/O interface 34, the processor 30 determines YES, and proceeds to step S53. When not receiving the imaging start command, the processor 30 determines NO and proceeds to step S56.

In step S53, the processor 30 causes the vision sensor 14 to image the workpiece W as in step S2 described above. As a result, the vision sensor 14 images the ith image data ID1_ᵢ and supplies it to the processor 30. In step S54, the processor 30 stores the ith image data ID1_ᵢ acquired in the latest step S53 in the memory 32 together with the identification number “i”. In step S55, the processor 30 increments the identification number “i” by “1” (i=i+1).

In step S56, the processor 30 determines whether or not an imaging end command has been received. For example, the operator operates the input device 40 to input the imaging end command. When receiving the imaging end command, the processor 30 determines YES, and ends the flow shown in FIG. 17. When not receiving the imaging end command, the processor 30 determines NO and returns to step S52.

For example, after the end of step S55, the operator changes the arrangement of the workpieces W in the container B illustrated in FIG. 1 without inputting the imaging end command Next, the operator operates the input device 40 to input an imaging start command. Then, the processor 30 determines YES in step S52, executes steps S53 to S55 on the workpiece W after the arrangement in the container B has changed, and acquires the i+1th image data ID1_ᵢ₊₁.

After the flow shown in FIG. 17 ends, the processor 30 executes the flow shown in FIG. 18. Note that in a flow shown in FIG. 18, a process similar to those of the flows shown in FIGS. 3 and 17 will be denoted by the same step number and redundant description will be omitted. The processor 30 proceeds to step S51 when determining YES in step S1, and proceeds to step S6 when determining NO.

Then, the processor 30 ends the flow shown in FIG. 18 when determining YES in step S6, and returns to step S1 when determining NO. In step S51, the processor 30 sets the identification number “i” of the image data ID1_ᵢ to “1”.

In step S62, the processor 30 generates image data ID2_ᵢ in which the workpiece feature WP is displayed. Specifically, the processor 30 reads out the ith image data ID1_ᵢ identified by the identification number “i” from the memory 32. Then, on the basis of the ith image data ID1_ᵢ, the processor 30 generates, for example, the ith image data ID2 as shown in FIG. 4, as a GUI through which the operator can visually recognize the workpiece feature WP shown in the ith image data ID1_ᵢ.

After Step S62, the processor 30 sequentially executes steps S4 and S5 described above using the ith image data ID2_ᵢ to adjust the parameter PMₙ such that it is optimized for the ith image data ID2_ᵢ. Then, the processor 30 executes step S55 and increments the identification number “i” by “1” (i=i+1).

In step S64, the processor 30 determines whether or not the identification number “i” exceeds the maximum value i_{MAX} (i>i_{MAX}). The maximum value i_{MAX} is the total number of image data ID1_ᵢ acquired by the processor 30 in the flow of FIG. 17. The processor 30 determines YES when i>i_{MAX} in step S64 and ends the flow shown in FIG. 18, and determines NO when i≤i_{MAX} and returns to step S62. In this manner, the processor 30 repeatedly executes the loop of steps S62, S4, S5, S55, and S64 until determining YES in step S64, and adjusts the parameter PMₙ for all the image data ID2_ᵢ (i=1, 2, 3, . . . , i_{MAX}).

As described above, in the present embodiment, a plurality of image data ID1_ᵢ of the workpieces W arranged at various positions are accumulated in the flow shown in FIG. 17, and thereafter, the parameter PM is adjusted using the plurality of accumulated image data ID1_ᵢ in the flow shown in FIG. 18. With this configuration, the parameter PM can be optimized for the workpieces W arranged at various positions.

Note that in the flow shown in FIG. 17, the processor 30 may omit step S52, execute step S64 described above instead of step S56, and determine whether or not the identification number “i” exceeds the maximum value i_{MAX} (i>i_{MAX}). The threshold value i_{MAX} used in step S64 is determined in advance as an integer greater than or equal to 2 by the operator.

Then, the processor 30 ends the flow of FIG. 17 when determining YES in step S64, and returns to step S53 when determining NO. Here, in such a variation of the flow of FIG. 17, the processor 30 may change the position (specifically, the position and orientation) of the vision sensor 14 every time step S53 is executed, and image the workpieces W from different positions and the visual line direction A2. According to this variation, even if the operator does not manually change the arrangement of the workpieces W, the image data ID1_ᵢ obtained by imaging the workpieces W in various types of arrangement can be automatically acquired and accumulated.

Note that the processor 30 may execute the flows shown in FIGS. 3, 17, and 18 in accordance with a computer program stored in the memory 32 in advance. This computer program includes an instruction statement for causing the processor 30 to execute the flows shown in FIGS. 3, 17, and 18, and is stored in the memory 32 in advance.

In the above-described embodiment, the case where the processor 30 causes the robot 12 and the vision sensor 14 serving as actual machines to acquire the image data ID1 of the actual workpiece W has been described. However, the processor 30 may cause a vision sensor model 14M, which is a model of the vision sensor 14, to virtually image the workpiece model WM, whereby the image data ID1 can be acquired.

In this case, the processor 30 may arrange, in the virtual space, a robot model 12M, which is a model of the robot 12, and the vision sensor model 14M fixed to an end effector model 28M of the robot model 12M, and may cause the robot model 12M and the vision sensor model 14M to simulatively operate in the virtual space to execute the flows shown in FIGS. 3, 17, and 18 (i.e., the simulation). With this configuration, the parameter PM can be adjusted by a so-called offline operation without using the robot 12 and the vision sensor 14 serving as actual machines.

Note that the input reception section 56 can be omitted from the above-described device 50. In this case, the processor 30 may omit steps S12 to S14 in FIG. 5 and automatically acquire the matching position MP from the image data ID2 generated in step S11. For example, a learning model LM showing the correlation between the workpiece feature WP shown in the image data ID and the matching position MP may be stored in the memory 32 in advance.

For example, the learning model LM can be constructed by iteratively giving a learning data set of the image data ID showing at least one workpiece feature WP and the data of the matching position MP in the image data ID to a machine learning apparatus (e.g., supervised learning). The processor 30 inputs the image data ID2 generated in step S11 to the learning model LM. Then, the learning model LM outputs the matching position MP corresponding to the workpiece feature WP shown in the input image data ID2. Thus, the processor 30 can automatically acquire the matching position MP from the image data ID2. Note that the processor 30 may be configured to execute the function of the machine learning apparatus.

In the above-described embodiment, the case where the workpiece feature WP is constituted by the three-dimensional point group in the image data ID2 has been described. However, no such limitation is intended, and in step S3, the processor 30 may generate the image data ID2 as a distance image in which the color or color tone (shading) of each pixel showing the workpiece feature WP is represented so as to change in accordance with the above-described distance d.

In addition, in step S3, the processor 30 may generate the image data ID1 acquired from the vision sensor 14 as image data to be displayed on the display device 38 and display the image data ID1 on the display device 38 without newly generating the image data ID2. Then, the processor 30 may execute steps S3 and S4 using the image data ID1.

Furthermore, the image generation section 52 can be omitted from the above-described device 50, and the function of the image generation section 52 can be obtained by an external device (e.g., the vision sensor 14 or a PC). For example, the processor 30 may adjust the parameter PM using, without any change, the image data ID1 imaged by the vision sensor 14 in the original data format. In this case, the vision sensor 14 has the function of the image generation section 52.

The vision sensor 14 is not limited to a three-dimensional vision sensor, and may be a two-dimensional camera. In this case, the processor 30 may generate the two-dimensional image data ID2 on the basis of the two-dimensional image data ID1, and execute steps S3 and S4. In this case, the sensor coordinate system C3 is a two-dimensional coordinate system (x, y).

In the embodiment described above, the case where the device 50 is mounted on the control device 16 has been described. However, no such limitation is intended, and the device 50 may be mounted on a computer (e.g., a desktop PC, a mobile electronic device such as a tablet terminal device or a smartphone, or a teaching device for teaching the robot 12) different from the control device 16. In this case, the different computer may include a processor that functions as the device 50 and may be communicably connected to the I/O interface 34 of the control device 16.

Note that the end effector 28 described above is not limited to a robot hand, and may be any device that performs a work on a workpiece (a laser machining head, a welding torch, a paint applicator, or the like). Although the present disclosure has been described above through the embodiments, the above embodiments are not intended to limit the invention as set forth in the claims.

### REFERENCE SIGNS LIST

10 Robot system
12 Robot
14 Vision sensor
16 Control device
30 Processor
50 Device
52 Image generation section
54 Position detecting section
56 Input reception section
58 Matching position acquiring section
60 Parameter adjustment section
62 Command generation section

1. A device comprising:
a position detecting section configured to obtain, as a detection position, a position of a workpiece in image data in which a workpiece feature of the workpiece imaged by a vision sensor is displayed, using a parameter for collating a workpiece model obtained by modeling the workpiece with the workpiece feature in the image data;
a matching position acquiring section configured to acquire, as a matching position, a position of the workpiece model in the image data when the workpiece model is arranged so as to coincide with the workpiece feature in the image data; and
a parameter adjustment section configured to adjust the parameter so as to enable the position detecting section to obtain the detection position as a position corresponding to the matching position, on the basis of data representing a difference between the detection position and the matching position.

2. The device according to claim 1, further comprising an image generation section configured to generate the image data.

3. The device according to claim 2, wherein the image generation section further displays the workpiece model in the image data,
wherein the device further includes an input reception section configured to receive first input data for displacing a position of the workpiece model in the image data, and
wherein the matching position acquiring section acquires the matching position when the image generation section displaces the position of the workpiece model displayed in the image data in response to the first input data and arranges the workpiece model such that the workpiece model coincides with the workpiece feature.

4. The device according to claim 3, wherein the image generation section is configured to:
display the workpiece model at the detection position acquired by the position detecting section;
display the workpiece model at a randomly-determined position in the image data; or
display the workpiece model at a position which is determined in accordance with a predetermined rule in the image data.

5. The device according to claim 3, wherein the input reception section further receives second input data for deleting the workpiece model from the image data or adding a second workpiece model to the image data, and
wherein the image generation section deletes the displayed workpiece model from the image data or additionally displays the second workpiece model in the image data, in accordance with the second input data.

6. The device according to claim 3, wherein the image generation section deletes the displayed workpiece model from the image data or additionally displays a second workpiece model in the image data, in accordance with a predetermined condition.

7. The device according to claim 1, wherein the parameter adjustment section adjusts the parameter by repeatedly executing a series of operations of:
determining a change amount of the parameter which allows the difference to be reduced, on the basis of the data representing the difference;
updating the parameter by changing the parameter by the determined change amount; and
acquiring data representing a difference between the detection position obtained by the position detecting section using the updated parameter and the matching position.

8. The device according to claim 1, wherein the workpiece feature is acquired by virtually imaging the workpiece model with a vision sensor model being a model of the vision sensor.

9. A robot system comprising:
a vision sensor configured to image a workpiece;
a robot configured to execute a work on the workpiece;
a command generation section configured to generate an operation command for operating the robot, on the basis of image data imaged by the vision sensor; and
the device according to claim 1,
wherein the position detecting section acquires, as a detection position, a position of the workpiece in the image data imaged by the vision sensor, using the parameter adjusted by the parameter adjustment section, and
wherein the command generation section is configured to:
acquire position data of the workpiece in a control coordinate system for controlling the robot, on the basis of the detection position acquired by the position detecting section using the adjusted parameter; and
generate the operation command on the basis of the position data.

10. A method comprising, by a processor:
obtaining, as a detection position, a position of a workpiece in image data in which a workpiece feature of the workpiece imaged by a vision sensor is displayed, using a parameter for collating a workpiece model obtained by modeling the workpiece with the workpiece feature in the image data;
acquiring, as a matching position, a position of the workpiece model in the image data when the workpiece model is arranged so as to coincide with the workpiece feature in the image data; and
adjusting the parameter so as to enable the position detecting section to obtain the detection position as a position corresponding to the matching position, on the basis of data representing a difference between the detection position and the matching position.

11. A computer-readable storage medium configured to storage a computer program causing the processor to execute the method according to claim 10.
